(19) United States
(12) Patent Application Publication
(10) Pub. No.: US 2018/0044553 A1
(43) Pub. Date: Feb. 15, 2018

(54) LOW-TEMPERATURE PLASMA TREATMENT

(71) Applicant: TESA SE, Norderstedt (DE)

(72) Inventors: Arne KOOPS, Neu-Lankau (DE); Klaus KEITE-TELGENBÜSCHER, Hamburg (DE)

(73) Assignee: TESA SE, Norderstedt (DE)

(21) Appl. No.: 15/558,257

(22) PCT Filed: Mar. 11, 2016
(86) PCT No.: PCT/EP2016/055227

§ 371 Date: Sep. 14, 2017

(30) Foreign Application Priority Data
Mar. 17, 2015 (DE) 10 2015 204 753.9

(51) Int. Cl. C09J 5/02

(52) U.S. Cl. CPC C09J 5/02; C09J 2433/00

(57) ABSTRACT

Method for bonding a substrate surface of a substrate to an adhesive surface of an adhesive by generating a low-temperature plasma in a low-temperature plasma generator, activating the substrate surface and/or the adhesive surface with the low-temperature plasma, and thereafter layering the substrate surface and the adhesive surface atop one another to form a bonded assembly.

This is a 371 of PCT/EP2016/055227 filed 11 Mar. 2016, which claims foreign priority benefit under 35 U.S.C. 119 of German Patent Application 10 2015 204 753.9 filed Mar. 17, 2015, the entire contents of which are incorporated herein by reference.

The invention relates to a method for bonding a substrate surface of a substrate to an adhesive surface of an adhesive, and also to the use of a low-temperature plasma discharge configuration.

### BACKGROUND OF THE INVENTION

A fundamental problem when using adhesives to adhere to surfaces is the problem of applying these adhesives durably and firmly to the surface of the substrate. Such application requires particularly high adhesion of the pressure-sensitive adhesive on the surface. Adhesion is commonly used to denote the physical effect which causes two phases contacted with one another to hold together at their interface on the basis of intermolecular interactions occurring there. The adhesion therefore determines the attachment of the adhesive to the substrate surface, which can be determined as “tack” and as bonding force. In order to exert specific influence over the adhesion of an adhesive, it is common to add plasticizers and/or bonding force-boosting resins (known as “tackifiers”) to the adhesive.

A simple definition of adhesion may be “the energy of interaction per unit area” [in mN/m]; this quantity cannot be measured, owing to experimental restrictions such as lack of knowledge as to the true contact areas. Often described, moreover, is the surface energy (SE), with “polar” and “apolar” components. This simplified model has become established in the art. This energy and the components thereof are oftentimes measured by measurement of the static contact angles of various test liquids. Polar and apolar components are assigned to the surface tensions of these liquids. The polar and apolar components of the surface energy of the surface under test are ascertained from the observed angles of contact of the droplets on the test surface. This may be done, for example, in accordance with the OWKR model. An alternative method, customary in industry, is that of determination by means of test inks in accordance with DIN ISO 8296. In the context of such discussions, the terms “polar” and “high-energy” are often equated, as are the terms “apolar” and “low-energy”. The finding behind this is that polar dipole forces are comparatively strong, as compared with so-called “disperse” or “apolar” interactions, which are developed without participation of permanent molecular dipoles. The basis for this model of interface energy and interface interactions is the idea that polar components interact only with polar components, and apolar components only with apolar components.

However, a surface may also have small or moderate polar components within the surface energy, without the surface energy being “high”. As a guide, as soon as the polar component of the SE is greater than 3 mN/m, the surface is said for the purposes of this invention to be “polar”. This corresponds approximately to the practical lower detection limit.

In principle there are no hard limits for terms such as high-energy and low-energy. For the purpose of the discussion, the limit is set at 38 mN/m or 38 dyn/cm (at room temperature). This is a level above which, for example, the printability of a surface is usually sufficient. For comparison, consideration may be given to the surface tension (=surface energy) of pure water, which is about 72 mN/m (dependent on factors including temperature).

Particularly on low-energy substrates such as PE, PP or EPDM, but also numerous finishes, there are great problems in achieving satisfactory adhesion, not only when using pressure-sensitive adhesives, but also other adhesives or coatings.

The physical pretreatment of substrates (by means of flame, corona or plasma, for example) for the purpose of improving bond strengths is commonplace particularly with liquid reactive adhesives. A function of the physical pretreatment in this case may also be the cleaning of the substrate, removing oils, for example, or a roughening for the purpose of enlarging the effective area.

In the context of a physical pretreatment, the term usually used is that of “activation” of the surface. This normally implies an unspecific interaction, in contrast, for example, to a chemical reaction according to the lock-and-key principle. Activation generally implies an improvement in wettability, printability or anchorage of a coating.

In the case of self-adhesive tapes, the application of an adhesion promoter to the substrate is commonplace. Such application, however, is often a costly and inconvenient manual step that is prone to errors.

The success associated with improving the adhesion of pressure-sensitive adhesives by means of physical pretreatment of the substrate (flame, corona, plasma) is not universal, since apolar adhesives such as synthetic rubber, for example, typically fail to profit from such pretreatment.

A corona treatment is defined as a surface treatment with filamentary discharges, generated by high alternating voltage between two electrodes, with the discrete discharge channels striking the surface to be treated; in this regard, see also Wagner et al., Vacuum, 71 (2003), pages 417 to 436. Without further qualification, the process gas is assumed to be ambient air.

In almost every case, the substrate is placed in or passed through the discharge space between an electrode and a counter-electrode, this being defined as “direct” physical treatment. Substrates in sheet form are typically passed between an electrode and a grounded roll.

In industrial applications more particularly, the term “corona” usually comprehends a dielectric barrier discharge (DBD). In this case, at least one of the electrodes consists of a dielectric, in other words an insulator, or is covered or coated with such a dielectric. The substrate in this case may also function as the dielectric.

The intensity of a corona treatment is specified as the “dose” in [Wmin/m²], this dose D obeying D=P/b*v, where P=electrical power [W], b=electrode width [m], and v=sheet velocity [m/min].

In almost every case, the substrate is placed in or passed through the discharge space between an electrode and a counter-electrode, this being defined as “direct” physical treatment. Substrates in sheet form are typically passed between an electrode and a grounded roll. Another term sometimes used is “ejected corona” or “single-side corona”. This is not comparable with an atmospheric pressure plasma, since highly irregular discharge filaments are “ejected” together with a process gas, and there is no possibility of stable, well-defined, efficient treatment.

FR 2 443 753 discloses an apparatus for surface treatment by means of a corona discharge. In this case, the two electrodes are arranged on the same side of the surface of the object to be treated, with the first electrodes being formed by a multiplicity of tips, along which a curved arrangement of a second electrode is provided. An alternating voltage of a few kV with a frequency of 10 kHz is applied between the two electrodes. The corona discharge along the field lines influences the surface passed in front of it, and leads to polarization of the surface, thereby improving the adhesion properties of a pressure-sensitive adhesive on the surface treated by means of the corona effect.

A disadvantage of the apparatus, however, is that the surface treatment by the corona effect is difficult to control.

A more uniform, intense corona treatment of materials of various kinds, shapes, and thicknesses can be enabled by completely avoiding the corona effect on the surface of the material to be treated, by choosing, in accordance with EP 0497996 B1, a dual-pin electrode, with each of the pin electrodes having a channel of its own for pressurization. Between the two tips of the electrodes, a corona discharge is produced which ionizes the stream of gas flowing through the channels and converts it into a plasma. This plasma then reaches the surface to be treated, where its effect in particular is to perform a surface oxidation that enhances the wettability of the surface. The nature of the physical treatment is referred to (here) as indirect, because the treatment is not performed at the location where the electrical discharge is generated. The surface is treated at or near atmospheric pressure, but the pressure in the electrical discharge space or gas channel can be increased. The plasma here is an atmospheric pressure plasma, which is an electrically activated, homogeneous, reactive gas which is not in thermal equilibrium, having a pressure close to the ambient pressure in the zone of action. Generally speaking, the pressure is 0.5 bar more than the ambient pressure. As a result of the electrical discharges and as a result of ionization processes in the electrical field, the gas becomes activated, and highly excited states are generated in the gas constituents. The gas used and the gas mixture are referred to as process gas. In principle it is also possible for gaseous substances such as siloxane, acrylic acids or solvent, or other constituents, to be admixed to the process gas. Constituents of the atmospheric pressure plasma may be highly excited atomic states, highly excited molecular states, ions, electrons, and unaltered constituents of the process gas. The atmospheric pressure plasma is generated not in a vacuum, but instead usually in an air environment. This means that the outflowing plasma, if the process gas is not already itself air, contains at least constituents of the ambient air.

In the case of a corona discharge as defined above, the high voltage applied causes filamentary discharge channels with accelerated electrons and ions to be formed. The low-mass electrons in particular strike the surface at high velocity, with energies sufficient to break most of the molecular bonds. The reactivity of the reactive gas constituents also produced is usually a minor effect. The broken bond sites then react further with constituents of the air or of the process gas. A critical effect is the formation of short-chain degradation products through electron bombardment. Treatments of higher intensity may also be accompanied by significant ablation of material.

The reaction of a plasma with the substrate surface intensifies the direct “incorporation” of the plasma constituents. Alternatively, on the surface, an excited state or an open bonding site and radicals may be produced, which then undergo further, secondary reaction, with atmospheric oxygen from the ambient air, for example. With certain gases such as noble gases, there is no likelihood of chemical bonding of the process gas atoms or molecules to the substrate. In this case the substrate is activated solely via secondary reactions.

The essential difference is therefore that in the case of the plasma treatment there is no direct exposure of the surface to discrete discharge channels. The effect therefore takes place homogeneously and non-aggressively, primarily by way of reactive gas constituents. In the case of an indirect plasma treatment, there are free electrons possibly present, but they are not accelerated, since the treatment takes place outside the generating electrical field.

The plasma treatment is therefore less destructive and more homogeneous than a corona treatment, since no discrete discharge channels impinge on the surfaces. Fewer short-chain degradation products of the treated material are formed; such products may form a layer with adverse effect on the surface. Consequently, it is often possible to achieve better wettabilities after plasma treatment by comparison with corona treatment, with longer-lasting effect.

The reduced extent of chain degradation and the homogeneous treatment by use of a plasma treatment make a substantial contribution to the robustness and effectiveness of the process taught.

The plasma device of EP 0 497 996 B1 features decidedly high gas flow rates in the region of 36 m³ per hour, with a 40 cm electrode width per gap. The high flow rates result in low residence time of the activated constituents on the surface of the substrate. Furthermore, the only plasma constituents reaching the substrate are those which are correspondingly long-lived and can be moved by a gas stream. Electrons, for example, cannot be moved by a gas stream, and therefore play no part.

A disadvantage with the stated plasma treatment, however, is the fact that the plasma impinging on the substrate surface has high temperatures of, in the most favorable case, at least 120° C. The resulting plasma, however, frequently possesses high temperatures of several 100° C. The known plasma cannons lead to high thermal entry into the substrate surface. The high temperatures may cause damage to the substrate surface, producing not only the activating products but also unwanted byproducts, which are known as LMWOMs for Low-Molecular-Weight Oxidized Materials. This highly oxidized and water-soluble polymer debris, which is no longer covalently bonded to the substrate, leads to a low level of resistance toward conditions of heat plus humidity.

It has now emerged, surprisingly, that on treatment of adhesives, adhesive surfaces and/or substrate surfaces with low-temperature plasma nozzles prior to bonding, it is likewise possible to achieve a significant rise in the bonding force, with the surfaces being highly activated and the bonded assemblies, after bonding to one another has taken place, possessing heat-plus-humidity resistance.

It is an object of the invention to provide a method as specified at the outset for bonding, wherein the resulting bonded assembly has a greater heat-plus-humidity resistance.

This object is achieved by a method having the features of claim 1.

### SUMMARY OF THE INVENTION

It has surprisingly emerged that for the bonding of a substrate surface of a substrate layer to an adhesive surface of an adhesive, an increase in the bonding force can also be achieved, especially at atmospheric pressure, by means of low-temperature plasma which is generated in a low-temperature discharge configuration, by activating the substrate surface and/or the adhesive surface with the low-temperature plasma and layering the substrate surface and the adhesive surface atop one another, after activation, to form a bonded assembly.

### DETAILED DESCRIPTION

By a low-temperature discharge configuration is meant, for example, a configuration which generally generates plasma of low temperature. In this case a process gas is conveyed into an electrical field, generated for example by a piezoelectric element, and is excited to a plasma. A plasma discharge space is the space within which the plasma is excited. The plasma emerges from an exit from the plasma discharge space.

A low-temperature plasma here refers to a plasma which has a temperature on striking the surface of at most 70° C., preferably at most 60° C., but more preferably at most 50° C. On account of the low temperature, the surfaces receive less damage, and, in particular, there is no formation of unwanted byproducts, the so-called LMWOMs (Low-Molecular-Weight Oxidized Materials). Particularly under ambient conditions of heat and humidity, these LMWOMs lead to a reduction in the peel adhesion of the adhesive on the substrate surface.

The low temperature of the plasma has the advantage, moreover, that a plasma nozzle of the plasma generator can be run over the treatment surface at a very small distance of less than 2 mm and this distance can be kept constant irrespective of the properties of the surface. As a result, in particular, the substrate surface can be activated at the same distance of the plasma nozzle as for the adhesive surface, resulting in a marked acceleration of the method. Before now, when using high-temperature plasma nozzles, it was necessary to adapt the distance of the plasma nozzle exit from the surface of the substrate to each material. In accordance with the prior art, this is done by increasing or reducing the treatment distance from the material surface, respectively. Such variation, however, is associated with increased time consumption and with complication of the activation process.

Atmospheric pressure here refers to the ambient pressure; in accordance with the invention, the term “ambient pressure” subsumes a maximum deviation from the prevailing ambient pressure of at most 0.1 bar, preferably 0.05 bar. This atmospheric pressure is prevalent at least in the zone of action and/or zone of discharge.

In accordance with the invention, the zone of action and/or the zone of discharge is not directly encapsulated or constructionally enclosed.

The fact that the zone of action and/or of discharge is not surrounded allows the plasma treatment of the individual surfaces to take place continuously. The part to be treated need not—as has hitherto been the usual case—be removed from a vacuum chamber or reduced-pressure chamber, the new part introduced into the vacuum chamber or reduced-pressure chamber, and a reduced pressure generated in the vacuum chamber or reduced-pressure chamber.

Employed favorably for the method of the invention are pressure-sensitive adhesives, known as PSAs, more particularly adhesives from the group of the acrylates. Substrates used are, in particular, plastics such as polypropylenes or LSE finishes such as Apo 1.2.

The low-temperature plasma is generated favorably by a plasma nozzle which is based on a piezoelectric effect. In this case, a process gas is passed in front of a piezoelectric material in a plasma discharge space. The piezoelectric material as primary zone is set in vibration via two electrodes by means of a low-volt alternating voltage. The vibrations are transmitted into the further, secondary region of the piezoelectric material. The opposite directions of polarization of the multilayer piezoceramic cause electrical fields to be generated. The potential differences that come about allow the generation of plasmas with low temperatures of at most 70° C., preferably 60° C., more preferably at most 50° C. There may be slight formation of heat only as a result of the mechanical work in the piezoceramic. In the case of common plasma nozzles with electric-arc-like discharges, this cannot be achieved, since the discharge temperature is above 900° C. for the excitation of the process gas.

In one variant of the invention, the plasma is used with a plasma nozzle unit without additional introduction of one or more precursor materials into the stream of working gas or into the plasma jet.

The object is also achieved by the use of a low-temperature plasma generator for activating surfaces of a bonded assembly having an adhesive surface and a substrate surface.

As low-temperature plasma generator it is possible in particular to use the Piezobrush PZ1 and the Piezobrush PZ2 provided by Reinhausen Plasma GmbH.

### BRIEF DESCRIPTION OF THE DRAWINGS

The invention is described with a number of exemplary embodiments in 14 figures, wherein:

FIG. 1a shows the activation of a substrate surface of a bond,

FIG. 1b shows the activation of an adhesive surface of the bond,

FIG. 1c shows the activation of the substrate surface and the adhesive surface of the bond,

FIG. 2 shows a graph on the plasma activation of the ACX^{plus} 7074 core

FIG. 3 shows a graph on the potential of a plasma treatment with different adhesives and ACX^{plus} cores

FIG. 4 shows a graph on the resistance of a plasma-activated bond without humidity effects

FIGS. 5a, 5b show resistance of plasma-activated bond at 40° C.180% relative humidity

FIG. 6 shows peel adhesion measurement of ACX^{plus} 7812 on piezoelectric plasma activation on LSE paint

FIG. 7 shows peel adhesion measurement of ACX^{plus} 7812 on piezoelectric plasma activation on polypropylene

FIG. 8 shows peel adhesion 90° comparison chemical primer vs. Corona vs. Plasma-ACX^{plus} 7074 on LSE paints from PPG

FIG. 9 shows activation efficiency Corona vs. Plasma

FIG. 10a shows a schematic view of the operating principle of a low-plasma-temperature plasma generator

FIG. 10b shows directions of polarization occurring within the low-plasma-temperature plasma generator of FIG. 10a

In-house Tesa® adhesive units are evaluated for their behavior under plasma conditions. For this purpose, different substrate layers 1 with associated substrate surfaces 2 are selected. Plasma treatments are carried out first with the Plasmatreat technology (Open-Air Plasma). This is done using a Plasmajet from Plasmatreat, Steinhagen. The Plasmajet is a plasma cannon for generating an atmospheric pressure plasma. A substrate surface and/or an adhesive surface 2 is treated with the atmospheric pressure plasma.

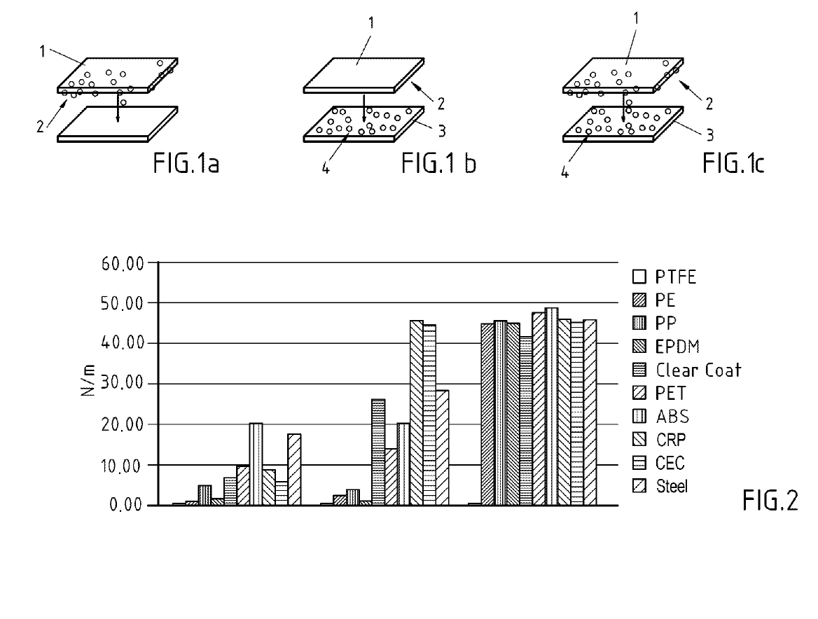

In the context of applying a layer 3 of adhesive to the substrate layer 1, there are in principle three options for the plasma treatment. Firstly, only the substrate surface 2 may be activated, as per FIG. 1a. Secondly, as per FIG. 1b, only an adhesive surface 3 of a layer 4 of adhesive can be activated, or, thirdly, as per FIG. 1c, both the substrate surface 2 and the adhesive surface 4 can be activated. The three possibilities are represented in FIGS. 1a, 1b and 1c.

FIG. 2 illustrates an experimental series. Tesa® ACX^{plus} 7074 is selected as substrate layer 1 and adhesive layer 2. Different substrates are selected, identified in FIG. 2 by their usual codes. The 10 bars per treatment option correspond, from left to right, to the 10 codes to the right of the graph, from top to bottom.

It is evident from FIG. 2 that the activation of both bonding surfaces acts synergistically in almost all cases. This means that in the relevant cases tested, the activation of the adhesive surface 4 and of the substrate surface 2 is the best interface for improving adhesive properties.

It can also be ascertained that the peel adhesion of an adhesive bond between substrate layer 1 and adhesive layer 3 reaches the level of the double-sided treatment only in exceptional cases when only the substrate is activated. Treatment of adhesive alone may show, in specific combinations of materials, that the quality of a double-sided treatment can be achieved.

Determining the peel adhesion of an adhesive tape on a steel test plate takes place under testing conditions of 23° C.+/−1° C. temperature and 50%+/−5% relative humidity. The adhesive tapes are cut to a width of 20 mm as test specimens and are adhered to a steel plate. Prior to the measurement, the test plate is cleaned and conditioned. For this purpose, the steel plate was wiped down first with acetone and left to stand in the air for 5 minutes to allow the solvent to evaporate. The side of the single-layer test specimen facing away from the test plate is then lined with 36 μm etched PET film, thereby preventing the adhesive tape from stretching during measurement. This is followed by the rolling of the test specimen onto the steel substrate. For this purpose, the tape is rolled down five times back and forth with a 4 kg roller at a rolling speed of 10 m/min. 20 minutes after roller application, the steel plate is inserted into a special mount, which allows the test specimen to be peeled vertically upward at an angle of 90°. The peel adhesion measurement takes place using a Zwick tensile testing machine. The results of measurement are reported in N/cm and are averaged from three individual measurements.

An important finding is that the activation of bonding surfaces of which one is a Tesa®ACX^{plus} surface of a Tesa®ACX^{plus} adhesive tape is able to achieve a significant improvement in the peel adhesion. In the case of the ACX^{plus} adhesive tapes, these are commercially available adhesive tapes from Tesa®. The ACX^{plus} adhesive tapes have a viscoelastic carrier and two adhesive surfaces opposite one another on the carrier, these surfaces consisting of the same or a modified chemical structure. Hence the peel adhesion-boosting effect also extends to pure viscoelastic carrier systems. It is typically the viscoelastic carriers which are responsible for the desired properties in the finished product (thickness, damping properties, etc.), these carriers not having been developed primarily for the adhesive properties. The carrier systems are therefore frequently laminated with dedicated functional adhesive layers in order to generate the adhesive properties.

ACX^{plus} carrier systems feature a single-layer construction composed of an acrylate layer. In the great majority of cases, the performance properties of the plasma-activated viscoelastic ACX^{plus} carrier systems as per FIG. 2 are comparable with plasma-activated three-layer constructions, composed of a carrier layer on which adhesive layers have been applied to both surfaces. The peel adhesion, however, may also be well above these.

FIG. 2 shows the peel adhesion, measured in the standard method, of an adhesive bond between the ACX^{plus} 7074 adhesive without functional compound, which in this case is a resin-modified acrylate adhesive, on ten different substrate surfaces 2. The substrate surfaces are PTFE (polytetrafluoroethylene), PE (polyethylene), MOPP (monoaxial oriented polypropylene films), PU (polyurethane), EPDM (ethylene-propylene-diene rubber), ClearCoat from BASF, PET (polyethylene terephthalate), ABS (acrylonitrile-butadiene-styrene), CRP (carbon fiber-reinforced plastic), CEC (cathodic electrocoat), and steel. Three treatment options by means of plasma treatment are selected. The left-hand bar group represents the peel adhesion of an ACX^{plus} 7064 adhesive surface on the ten aforementioned different substrate surfaces without plasma treatment of one of the two bonding surfaces 2, 4.

The middle bar group shows the peel adhesion if only the adhesive surface 4 is activated with the atmospheric pressure plasma, and the right-hand bar group represents the peel adhesion if both the adhesive surface 4 and the respective substrate surface 2 are activated.

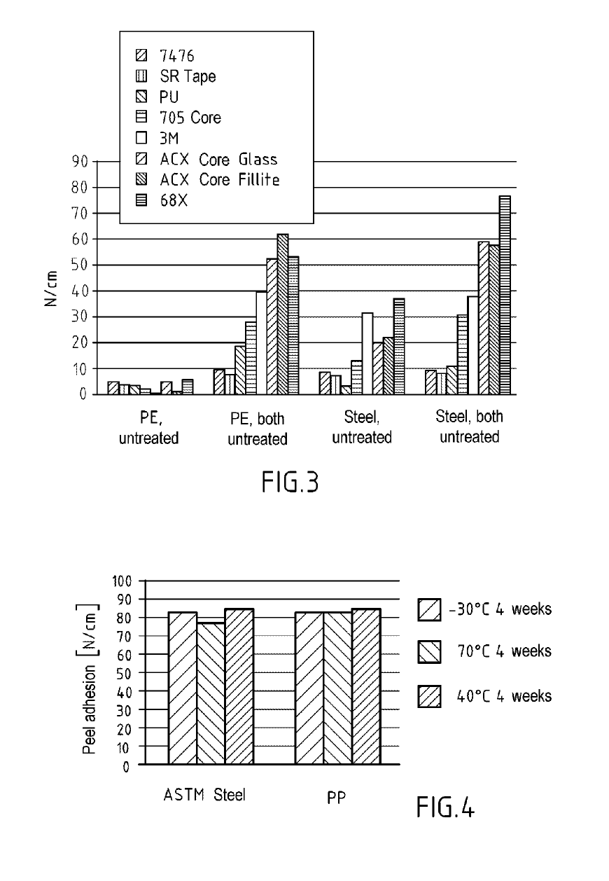

FIG. 3 includes, in an overview, the results of the peel adhesion testing of different plasma-treated adhesives on PE (polyethylene) surfaces or a steel surface.

The first bar group relates to the peel adhesion measurements on untreated PE surface, and the second bar group to peel adhesion measurements on PE surfaces when both the adhesive surface and the substrate surface are activated. The third bar group relates to peel adhesion measurements on a steel surface without plasma treatment of one of the two bonding surfaces, and the fourth bar group relates to the peel adhesion measurements of various adhesives on a steel surface when both bonding surfaces are plasma-activated.

The adhesives are ACX^{plus} 7476, MOPP, PU (polyurethane), ACX^{plus} 705x from Tesa®, an adhesive from 3M, which is a VHB grade from 3M, ACX^{plus} with glass or Fillite cores, and ACX^{plus} 68xx single-layer, foamed.

The results show that the plasma treatment on all adhesives possesses a positive effect, but that the absolute peel adhesion figures are differently pronounced. A moderate increase in the peel adhesion is recorded for the adhesive tape with ACX^{plus} 7476 and also for the pure PU adhesive, in part limited via cohesive failures and mixing breakages. It is observed, however, that the tesa acrylate cores without adhesive, ACX^{plus} core with hollow glass beads and ACX^{plus} core with Fillite that were investigated respond strongly to the plasma treatment, which is able to bring about a significant boost in peel adhesion on PE and steel. The 3M product as well (straight acrylate, single-layer, with hollow glass beads) profits from the treatment. Single-layer acrylate cores have a high potential for plasma activations.

A fundamental potential evaluation is shown in table 1:

TABLE 1

| | | Strong |
|---|---|---|
| | | improvement by |
| ACXplus | Investigation of . . . | plasma possible? |
| Properties | Peel adhesion | Yes |
| | Shear strength | Yes |
| | Instantaneous peel adhesion | Yes |
| Substrates | EPDM, PP, PE, PET, . . . | Yes |
| | Steel, aluminum, . . . | Yes |
| | Finishes | Yes |
| | Teflon | No |
| Compositions | Acrylate adhesives | Yes |
| | Natural rubber | Yes |
| | Synthetic rubber | Yes |
| | PU | Yes |
| | Ac-SBC blends/HPSR | Yes |
| Construction | Conventional adhesive tapes | Yes |
| | with film carrier | |
| | ACXplus cores: straight acrylate, | Yes |
| | foamed, filled | |
| | d/s foam fixing tabs | Yes |

The resistance of double-sided, plasma-activated bonds of ACX^{plus} 6812 adhesive on ASTM steel and PP after pure temperature storage, at temperatures of −30° C., 40° C. and 70° C. over 4 weeks, proved to be extremely stable, as per FIG. 4. There was no surface combination where the peel adhesion could be found to have reduced over time. In many cases, higher values relative to untreated references are obtained.

Long-term aging stability under moisture is critically influenced by the quality of the bonding interfaces. The aim of a plasma treatment is to create appropriate reactive centers on the adhesive surface in order to increase the bond to the substrate and to alleviate or to eliminate aging phenomena caused for example by storage conditions of heat plus humidity.

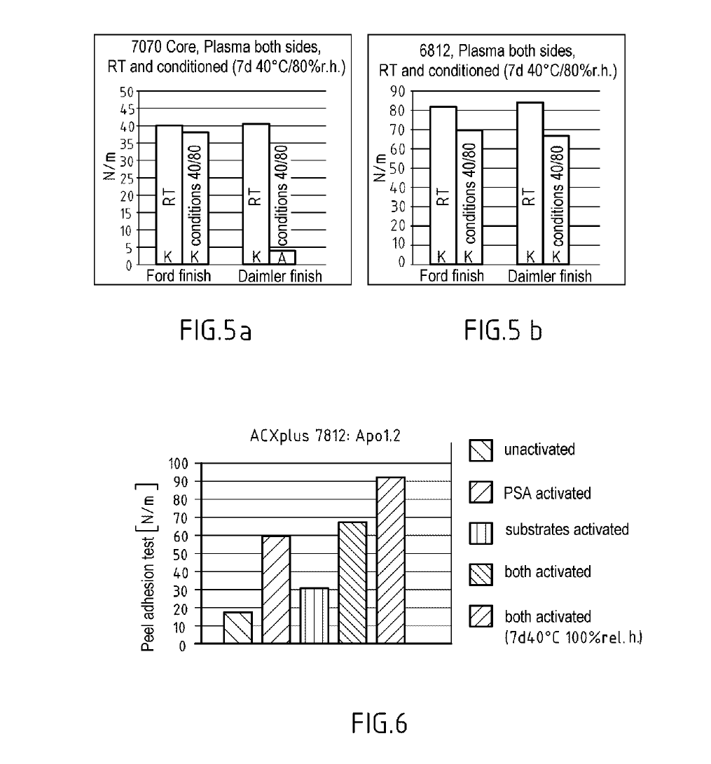

As described above, a plasma does not act in the volume region of an adhesive, but may, via plasma-induced hydrophilization, give rise to or promote the advance of a water front into the interface. The moisture that is absorbed triggers physical and chemical changes in the interface. In this case it is possible, via suitable parameters of the Plasma treatment, such as distance of the nozzle from the bond surface, and the speed, to eliminate heat-plus-humidity weakness or reduce it, as shown by the results according to FIG. 5a and FIG. 5b.

FIG. 5a shows the peel adhesion of an ACX^{plus} 7070 adhesive on two automobile finishes after seven days of storage of the bond at room temperature and at 40° C. and 80% relative humidity. FIG. 5b saw a second measurement carried out in relation to an ACX^{plus} 6812 adhesive under the same climatic conditions set out above. The left-hand pair of bars in each of FIG. 5a and FIG. 5b relates to a Ford finish, and the right-hand pair of bars in each of FIG. 5a and FIG. 5b relates to a Daimler finish. In all of the experimental arrangements, both bond surfaces 2, 4 were activated with a Plasmajet.

But even without optimization and use of standard parameters such as 12 mm distance, 5 m/min Plasmajet treatment speed, combinations of materials are frequently already resistant to heat-plus-humidity conditions. In this regard, see table 2.

TABLE 2
Heat plus humidity resistance varies by substrate

| | | | | PP |
|---|---|---|---|---|
| | | EPDM | PP | Test |
| Conditions | PA 90° | T30 | GF30 | plate |
| 3 d/RT | N/cm | 66* | 61* | 63* |
| Climate alternation | | 54* | 52* | 11** |
| 1000 h 38° C./95% r.h. | | | | |
| Climate alternation | | 57* | 55* | 9** |
| 10 d 85° C./−40° C.; 85% r.h. | | | | |
| BMW climate alternation PR303.5 d | | 63* | 62* | 16** |
| 240 h + 85° C./60% r.h.; −30° C. | | | | |

*= cohesive fracture/cohesive near to surface
**= adhesive fracture

Table 2 presents peel adhesion measurements for ACX^{plus} 6812 on three different substrate surfaces. The first column relates to a peel adhesion measurement on the adhesive bond after three days at room temperature; the second column relates to the peel adhesion measurement after 1000 h at 38° C. and 95% relative humidity. The third column describes the peel adhesion measurement after 10 days with climate alternation, and the fourth column describes a peel adhesion measurement after 5 days with climate alternation.

The thermal influence of the Plasmatreat treatment is held definitively responsible for the other unwanted side-effects, producing low-molecular-weight oxidizing materials (LMWOMs) on PP substrate and on the adhesive. Polymer or oligomer layers highly oxidized accordingly are not sufficiently bonded to the polymers in the volume of adhesive and, in addition, they are swellable or soluble in water.

It is found that the discharge technology of a plasma treatment occupies an essential role with regard to the humidity resistance. In the case of a Plasmajet, typically, the “afterglow” is generated via an electric arc or an arc-like discharge.

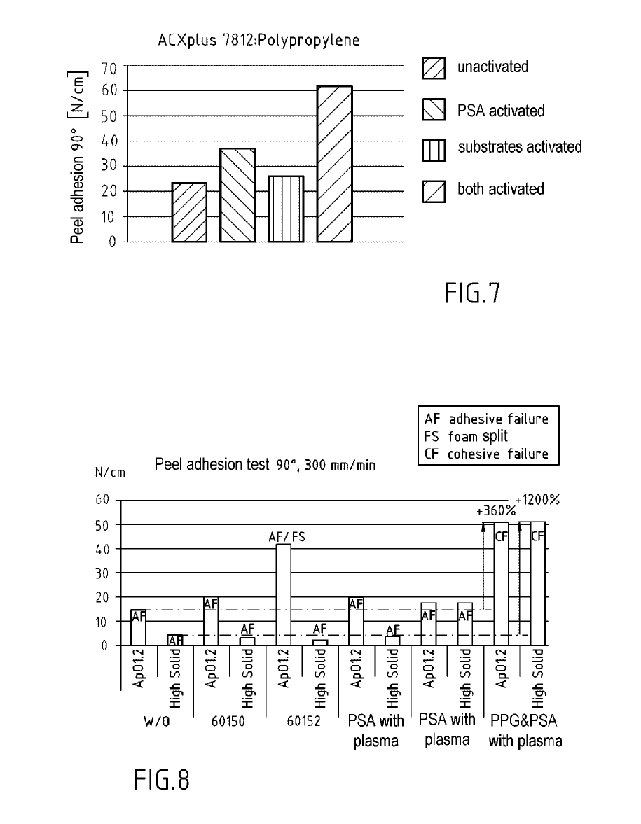

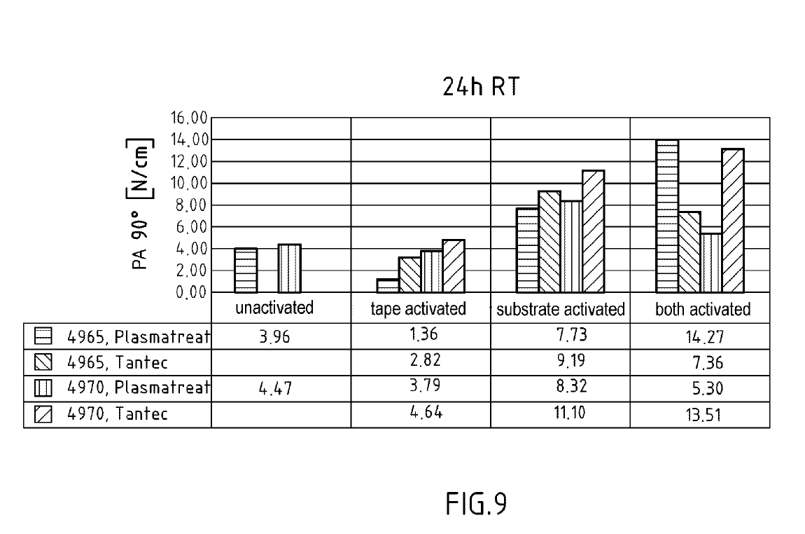

An alternative technology, from Reinhausen Plasma GmbH, generates the plasma by way of a piezoelectric effect, made possible by opposite directions of polarization of the crystal. The result of this discharge technology relative to an electric arc is a cold, non-thermal plasma. The temperatures are virtually at room temperature. Accordingly, thermal overtreatments and hence the formation of LMWOMs can be prevented or at least reduced. As a result, stable heat-and-humidity resistance of the adhesive can be demonstrated on LSE automotive finishes and low-energy polymers, in accordance with FIG. 6 and FIG. 7. In the case of bonding to finishes, a strong rise in the adhesive properties with plasma activation is a positive outcome.

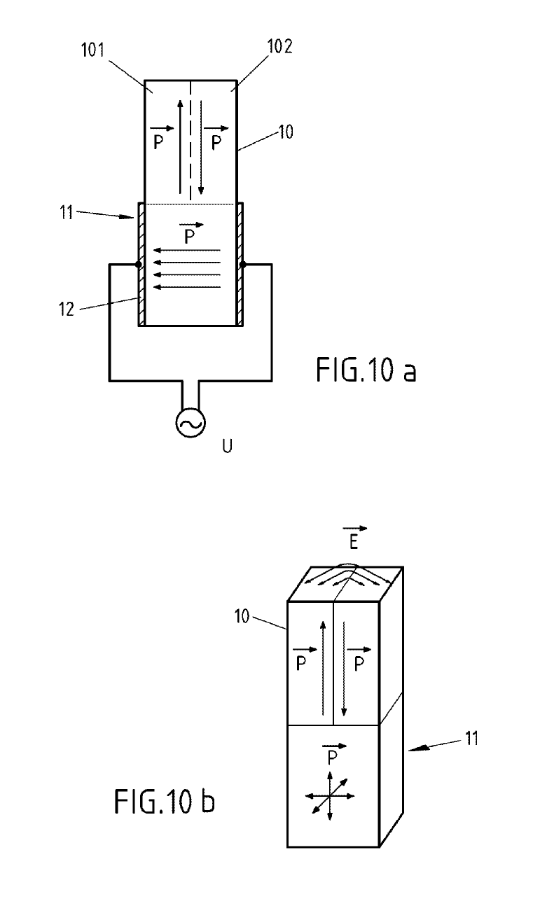

FIGS. 10a and 10b show, schematically, the functioning of the plasma cannon based on a piezoelectric effect. A preferentially oriented piezoceramic in this case is, for example, lead, zirconate-titanates. Known materials having piezoelectric properties are quartz as a piezoelectric crystal, and piezoelectric ceramics such as the aforementioned lead, zirconate-titanates are also conceivable.

In the exemplary embodiment as per FIG. 10a, 10b oppositely oriented piezoceramics are arranged alongside one another in a secondary region 10, while in a primary region 11 there is a condenser 12 having two opposing condenser plates, with each of the condenser plates being firmly connected to one of the piezoelectric elements 101, 102. Application of an alternating voltage U to the condenser plates produces mechanical vibration of the condenser plates of the condenser 12 by reversal of polarity. The mechanical vibration is transmitted to the piezoelectric elements 101, 102 and, in the condenser-facing end thereof, produces an alternating potential difference which corresponds in its frequency to the mechanical vibration of the condenser plates. The electrical field E generated by the potential difference is shown in FIG. 10b.

The piezoelectric elements 101, 102 themselves comprise an insulator, meaning that the safety requirements to be met are low. The frequency of the low-volt alternating voltage U at the condenser plates corresponds to the piezoelectric resonance frequency and is situated in the order of magnitude between 10 kHz and 500 kHz. Accordingly, a low-volt alternating voltage at the condenser is converted into a mechanical deformation which in turn generates a high-volt electrical alternating voltage at the free ends of the piezoelectric element 101, 102. The principle of the piezoelectric element is shown for example in EP 2 168 409 B1. Particularly in conjunction with cooling arrangements provided on piezoelectric elements, such elements are suitable, and so the plasma generated by the alternating electrical field can be subsequently cooled and what is called a low-plasma-temperature plasma can emerge from an exit nozzle of the plasma cannon, which is not explicitly shown.

Low-plasma-temperature plasma cannons are marketed by Reinhausen Plasma GmbH. The Piezobrush PB1 generates plasma temperatures of only 70° C. The plasma of the Piezobrush PB2 has a temperature of 120° C.-250° C., depending on the exit nozzle.

The Piezobrush PZ2 produces a plasma having a plasma temperature of less than 50° C. Peel adhesion measurements result in FIG. 6 and FIG. 7.

The Piezobrush PZ2 is guided at a distance of 5 mm-10 mm and a speed of 5 m per minute over a substrate surface or a bonding agent surface, respectively, and so makes the surfaces ready for the bonding operation.

In view of the low plasma temperature of less than 50° C., the same plasma cannon can be used both to treat the substrate surface and to treat the bonding agent surface. The substrate surface in FIG. 6 is an LSE finish Apo1.2, while in FIG. 7 it is PP. The bonding agent surface is the surface of the ACX^{plus} 7812 adhesive tape.

FIG. 6 and FIG. 7 relate to peel adhesion measurements in which bonding takes place between a substrate surface 2 and a bonding area 4 of the double-sided adhesive tape ACX^{plus} 7812 from Tesa®.

In a first step of the method of the invention, the substrate surface, such as a metal or plastic surface, is treated with the Piezobrush PZ2. In a second step of the method, an outer side of the ACX^{plus} 7812 adhesive tape is activated with the same Piezobrush PZ2. The ACX^{plus} 7812 adhesive tape consists of an acrylate layer whose two outer surfaces are pressure-sensitively adhesive. The two surfaces of pressure-sensitive adhesive are normally covered with a protective film, which is peeled off prior to the bonding operation. In accordance with the invention, the outside of one layer of pressure-sensitive adhesive is activated with the Piezobrush PZ2 in preparation for the bonding operation. The Piezobrush here is run over the outer side of the layer of adhesive at the same distance of around 2 mm-5 mm, after which the activated substrate layer 1 and the activated layer 4 of pressure-sensitive adhesive are pressed against one another.

FIG. 6 shows the results of a peel adhesion test as per test standard, in which an adhesive tape 1 cm wide is applied to a substrate surface in accordance with the method described above. The left-hand bar shown in graph 1 shows the force to be applied for the removal of the double-sided adhesive tape at an angle of 90° when both surfaces—that is, both the substrate surface 2 and the surface 4 of pressure-sensitive bonding agent—are unpretreated. The second bar shows the pressure-sensitive adhesive tape in the test with activation only of the outer side of the layer of pressure-sensitive bonding agent; the third bar shows the peel adhesion on exclusive activation of the substrate layer, with the substrate being an LSE finish, namely APO 1.2. The fourth bar shows the force to be applied to remove the adhesive tape when both the substrate surface and the pressure-sensitive adhesive surface have been pretreated with the Piezobrush PZ2. The fifth bar shows the peel adhesion after storage (7 days, 40° C. at 100% relative humidity).

FIG. 7 shows the peel adhesion for the same test sequence for the double-sided adhesive tape ACX^{plus} 7812 when adhered to a PP layer, i.e., a polypropylene layer (PP). Here again, the first bar denotes the peel adhesion for untreated surfaces. The second bar denotes the peel adhesion when only the outer surface of pressure-sensitive bonding agent has been treated.

The fourth bar shows the force to be applied for removing the adhesive tape when both the substrate surface and the pressure-sensitive adhesive surface have been pretreated with the Piezobrush PZ2. The fifth bar shows the peel adhesion after storage (7 days, at 40° C. and 100% relative humidity).

High peel adhesion values after heat-plus-humidity storage, after 7 days at 40° C. and 100% relative humidity and, respectively, at 85° C. and 85% relative humidity, can be achieved through the low-temperature plasma treatment relative to an RT storage (room temperature storage).

### LIST OF REFERENCE SYMBOLS

1 Substrate layer
2 Substrate surfaces
3 Adhesive layer
4 Adhesive surface
10 Secondary region
11 Primary region
12 Condenser
P Direction of polarization
U Alternating voltage
101 Piezoelectric elements
102 Piezoelectric elements

1. A method for bonding a substrate surface (2) of a substrate layer (1) to an adhesive surface (4) of an adhesive (3),
by generating a low-temperature plasma in a low-temperature discharge configuration, under atmospheric pressure,
activating the substrate surface (2) and/or the adhesive surface (4) with the low-temperature plasma, and thereafter
layering the substrate surface (2) and the adhesive surface (4) atop one another to form a bonded assembly.

2. The method as claimed in claim 1, wherein the adhesive used comprises a pressure-sensitive adhesive.

3. The method as claimed in claim 2, wherein the pressure-sensitive adhesive used comprises an acrylic adhesive.

4. The method as claimed in claim 1, wherein a temperature of the plasma emerging from a plasma discharge space is at most 70° C.

5. The method as claimed in claim 4, wherein the plasma discharge space is moved at a distance of less than 15 mm over the surface to be treated.

6. The method as claimed in claim 1, wherein a substrate layer (1) with a substance selected from the group consisting of PTFE, PE, PP, EPDM, ClearCoat, PET, ABS, CRP, CEC, glass and steel is used.

7. The method as claimed in claim 1, wherein the adhesive surface (4) and the substrate surface (2) are treated with the same low-temperature discharge configuration at identical plasma temperature.

8. The method as claimed in claim 1, wherein the plasma is generated by passing a process gas in front of a piezoelectric electrode (101, 102) and thereby exciting a voltage field which forms between the piezoelectric electrode (101, 102) and a grounded electrode, and cooling the piezoelectric electrode (101, 102).

9. A method for activating surfaces of a bonded assembly having an adhesive surface (4) and a substrate surface (2), wherein said surfaces are activated with a low temperature plasma discharge configuration.
